(19) United States
(12) Patent Application Publication
(10) Pub. No.: US 2026/0064327 A1
(43) Pub. Date: Mar. 5, 2026

(54) STORAGE MEDIUM AND CONTROL METHOD OF INFORMATION PROCESSING APPARATUS

(71) Applicant: CANON KABUSHIKI KAISHA, Tokyo (JP)

(72) Inventor: AKIHIKO TOKUDA, Kanagawa (JP)

(21) Appl. No.: 19/302,394

(22) Filed: Aug. 18, 2025

(30) Foreign Application Priority Data
Aug. 29, 2024 (JP) 2024-147300

(51) Int. Cl. G06F 3/12

(52) U.S. Cl. CPC G06F 3/1208; G06F 3/1252; G06F 3/1253

(57) ABSTRACT

A non-transitory computer-readable storage medium storing executable instructions, which when executed by one or more processors of an apparatus, cause the apparatus to perform a method that includes accepting a processing setting made by a user, firstly displaying an image that illustrates a result of performing processing corresponding to the processing setting on an image to be printed, and secondly displaying an image illustrating placement of paper to be processed.

### BACKGROUND

### Field of the Technology

The aspect of the embodiments relates to a control device of a preview screen for performing layout printing and the like, a control method, and a storage medium.

### Description of the Related Art

There are known printer drivers that are installed in a host computer or the like to create and transmit print data to a printing apparatus connected to the host computer. The printer driver converts data from various applications that run on the host computer into the print data. Japanese Patent Application Laid-Open No. 2024-34233 discusses one of functions of the printer driver by which how to place an envelope to be printed on the printing apparatus used for printing is displayed on the screen of the printer driver.

However, it is difficult for users to visualize an output result, such as how the data created with an application installed in the host computer for the purpose of creating documents, spreadsheets, presentation materials, or the like will be printed on the envelope. In some cases, the envelope may not be printed properly if the user places the envelope on the printer incorrectly.

### SUMMARY

According to an aspect of the embodiments, a non-transitory computer-readable storage medium storing executable instructions, which when executed by one or more processors of an apparatus, cause the apparatus to perform a method that includes accepting a processing setting made by a user, firstly displaying an image that illustrates a result of performing processing corresponding to the processing setting on an image to be printed, and secondly displaying an image illustrating placement of paper to be processed.

Features of the disclosure will become apparent from the following description of embodiments with reference to the attached drawings. The following description of embodiments is described by way of example.

### BRIEF DESCRIPTION OF THE DRAWINGS

FIG. 1 is an overall view of a system.

FIG. 2 is a block diagram of a host computer.

FIG. 3 is a configuration diagram of modules of a printer driver.

FIGS. 4A to 4D are diagrams illustrating display example 1 of the printer driver.

FIGS. 5A and 5B are diagrams illustrating display example 1 of layout software.

FIG. 6 is a flowchart of basic operations representing the disclosure.

FIGS. 7A and 7B are diagrams illustrating display example 2 of the layout software.

FIG. 8 is a diagram illustrating display example 3 of the layout software.

FIG. 9 is a diagram illustrating display example 4 of the layout software.

FIGS. 10A to 10C are diagrams illustrating display example 5 of the layout software.

### DESCRIPTION OF THE EMBODIMENTS

### Embodiment 1

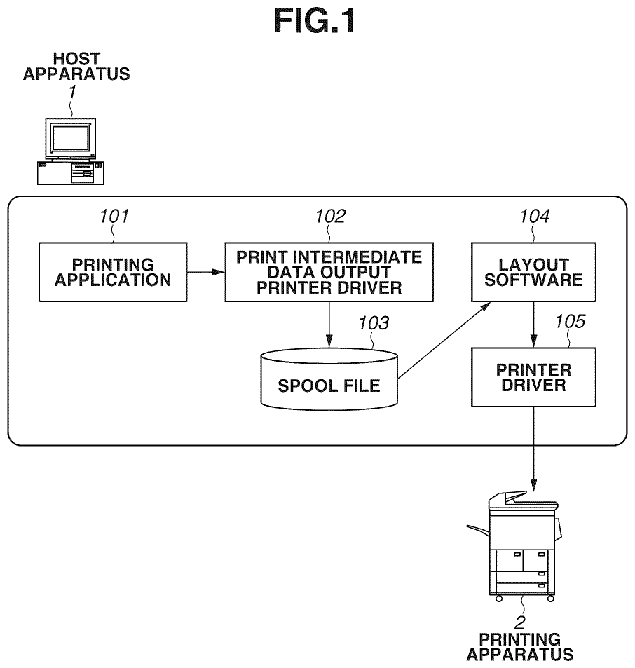

FIGS. 1 to 10 illustrate a first embodiment of the disclosure.

### System Configuration

A printer driver 301 in the embodiment is stored in an external memory 211 of a host computer, read into a random access memory (RAM) 202 and then executed by a central processing unit (CPU) 201.

FIG. 1 is a system configuration diagram of a printing system according to an embodiment of the disclosure. The printing system includes a host apparatus 1 and a printing apparatus 2. The host apparatus 1 is a personal computer or the like. Installed in the host apparatus 1 are a general printing application 101 capable of printing, a print intermediate data output printer driver 102, a printer driver 105, and layout software 104. The host apparatus 1 and the printing apparatus 2 are communicably connected to each other. The host apparatus 1 is an example of an information processing apparatus.

The print intermediate data output printer driver 102 is a printer driver for outputting print data as a spool file 103. A user browses and edits any data in the print application 101, and creates and displays an image to be printed. Then, the user selects the print intermediate data output printer driver 102 in the print application 101 and executes printing, whereby the spool file 103 is output as print intermediate data.

The output location of the spool file 103 is not particularly limited, and may be anywhere such as a Temp folder or AppData, as long as the layout software 104 described below can read the spool file 103. Possible formats for the spool file 103 include Extensible Markup Language (XML) Paper Specification (XPS), Enhanced Metafile (EMF), and the like, but any other format that the layout software 104 can process may be used.

The layout software 104 is software that assists printing by freely arranging print data, and displaying the print data from the print application 101 and an image of output to the envelope or the like on a preview screen.

The layout software 104 reads the spool file 103, displays the spool file 103, sets a print layout, and issues a print instruction to the printer driver 105. The layout software 104 is an example of a program of the disclosure.

A possible method for starting the layout software 104 is to prepare resident software that monitors printing to the print intermediate data output printer driver 102 and start the layout software 104 at the timing of printing. Other possible methods include a method by which the software is automatically started while the generation of the spool file 103 is monitored, a method by which the software is directly started by the print intermediate data output printer driver 102, and the like.

The printer driver 105 is a general printer driver for transferring print data to the printing apparatus 2. When the layout software 104 issues a print instruction to the printer driver 105, printing is executed on the printing apparatus 2. The printer drivers 102 and 105 can be configured such that processes are internally switched, so as to be one and the same printer driver.

With the above-described configuration in which the print intermediate data is edited by the layout software, it is possible to print data in various formats, including non-image data such as Microsoft Excel (registered trademark) files, in any layout while checking the actual print image. However, although the print intermediate data is used in the above embodiment, the disclosure is not limited to this example, and the user may start the layout software 104 manually and input image data in formats such as Bitmap or TIFF, for example.

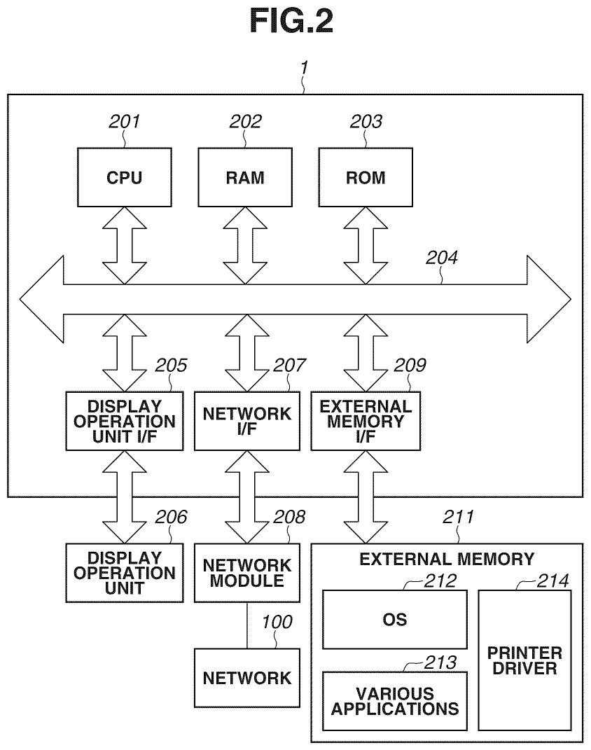

FIG. 2 is a block diagram illustrating an internal configuration of the host apparatus 1. In the host apparatus 1, the CPU 201 generally controls each device connected to a system bus 204 in accordance with programs stored in the RAM 202.

The RAM 202 also functions as a main memory, a work area, and the like for the CPU 201. A read only memory (ROM) 203 stores various basic programs and data of the system. A display operation unit interface (I/F) 205 controls the display of information on a display operation unit 206. The display operation unit 206 has a display function, and at the same time, is a touch panel that controls input from the user.

A network I/F 207 controls a network module 208 to implement network communication. An external memory I/F 209 controls access to an external memory 211 such as a flash memory or a solid state disk.

The external memory 211 stores an operating system program (hereinafter, OS) 212, various applications 213, and a printer driver 214, and functions as a storage medium where the host apparatus 1 can save or read data.

### Printer Driver

The printer driver will be described.

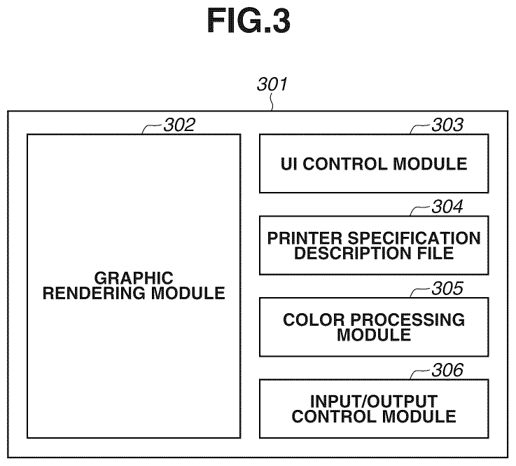

The printer driver includes a group of modules as illustrated in FIG. 3. The printer driver 214 (301) includes a graphic rendering module 302, a user interface (UI) control module 303, a printer specification description file 304, a color processing module 305, and an input/output control module 306. Depending on its functions, the printer driver may include other modules.

In the embodiment, the input/output control module 306 acquires information on the abilities of the printing apparatus 2 (paper size, paper type, or finishing methods such as stapling, hole punching, and binding) and the configuration of the printing apparatus 2, and changes the process settings displayed by the UI control module 303. This printer driver can be configured to perform processes with respect to a single printer or a plurality of printers, depending on the configuration of the modules of the printer driver.

For example, in order to support a plurality of printers by one printer driver, the graphic rendering module 302 and the UI control module 303 are created to be compatible with the plurality of printers. The printer specification description file 304 is included in the printer driver for each compatible printer.

In this method, the UI control module 303 displays and controls the UI in accordance with the printer specification description file 304. The graphic rendering module 302 is configured to issue printer control commands in a page description language suited to each printer.

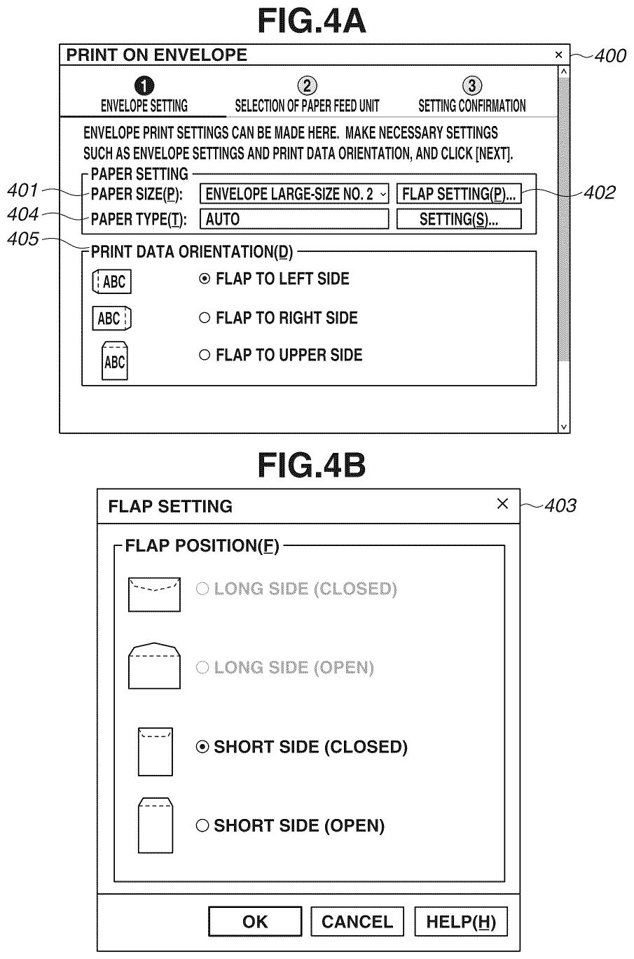

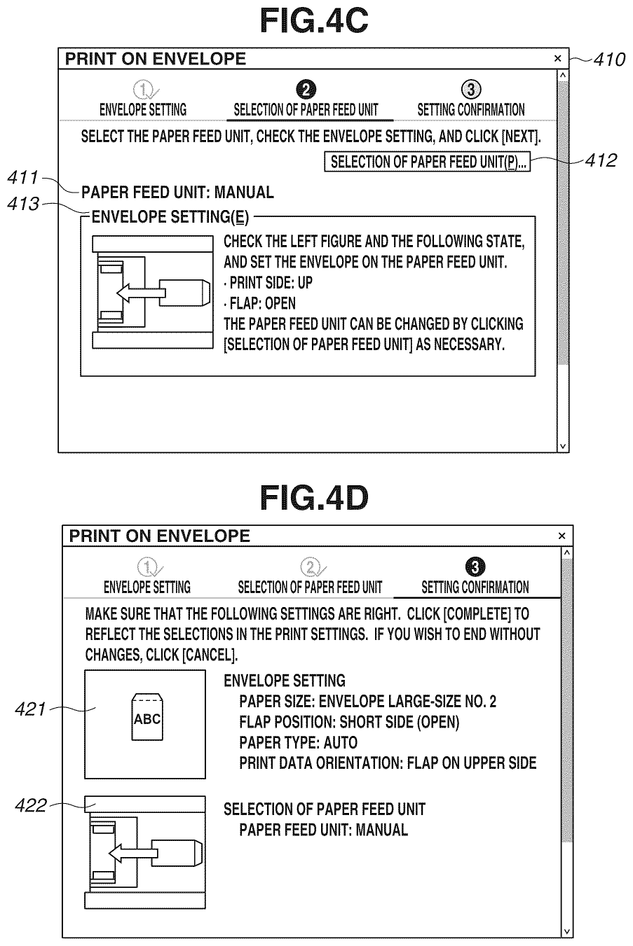

FIG. 4A illustrates an example of display on a screen 400 for setting various functions of envelope printing in the printer driver.

The screen 400 includes items for setting a paper size 401, a flap state 402, a paper type 404, and a positional relationship between the print data and the flap 405 (“print data orientation” in the display example) at the time of printing on an envelope.

FIG. 4B illustrates an example of a display on a setting screen 403 for the flap state.

FIG. 4C also illustrates an example of display on a screen for setting various functions of envelope printing in the printer driver, where the settings for an envelope feed unit 411 can be made on a screen (not illustrated) displayed upon pressing a setting button 412, and the settings are reflected in the display of the envelope feed unit 411. A setting method 413 is displayed, in which the series of settings made so far, such as the paper size 401, the flap state 402, and the envelope feed unit 411, are reflected.

FIG. 4D is a screen that displays all the settings made in FIGS. 4A to 4C together for confirmation, and illustrates various settings for envelope 421, and selection of paper feed unit and envelope placement 422.

With regard to “flap to right” and “flap to left” of the print data orientation 405, some envelopes may not be fed from the flap portion depending on the abilities of the printing apparatus 2. For this reason, switching the print data orientation may be achieved by using a 180-degree data rotation function (not illustrated) that is separately provided in the printer driver.

There are various possible methods for rotating data by 180 degrees. For example, the print data issued by the printer driver may be rotated (so that the top of the image becomes the bottom). Another possible method is to issue a command in the page description language of the printing apparatus 2 to rotate the page data (to instruct the printer controller to perform a 180-degree rotation process while leaving the image data as is).

The printer driver may be created such that various functions of the printer driver can be used (for example, with the layout software described below) via a Software Development Kit (SDK) or the like. In the disclosure, the SDK is also used in the embodiments described below.

### Layout Software

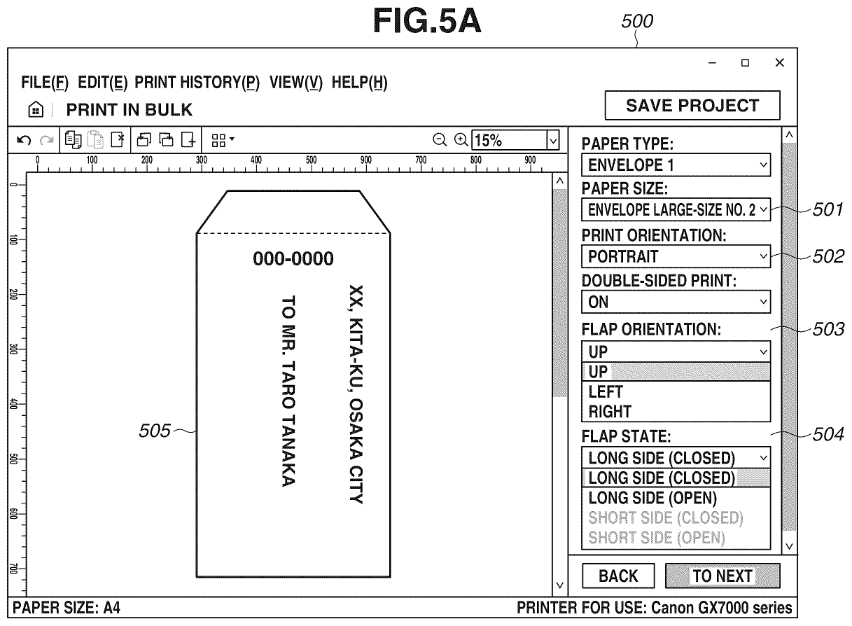

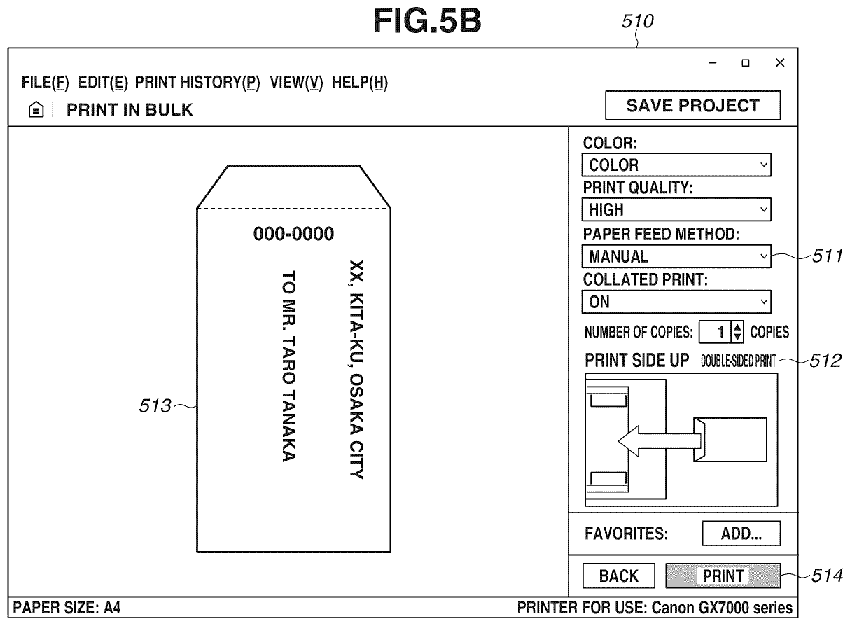

FIG. 5A is a diagram illustrating an example of a screen 500 of the layout software 104.

After acquisition of the spool file 103, the screen 500 is displayed on the display of the host apparatus 1 to accept various settings.

The various settings may selectively include a selected paper size 501, a paper type, and a print orientation 502. The various settings may also selectively include print instructions such as flap orientation 503 in a case where the selected paper size is an envelope, and a flap open/closed state 504 in a case where the selected paper size is an envelope. The print data of the application 213 and an output image of the selected paper size 501 are displayed in an image 505.

FIG. 5B illustrates an image 512 indicating the placement of paper on the printing apparatus 2 to be used for actual printing, based on various settings confirmed on the screen 500 of the layout software 104 and other settings. Other settings include a color, print quality, collated print, a paper feed method 511, and the like, for example. When a print button 514 is pressed, a print instruction is output.

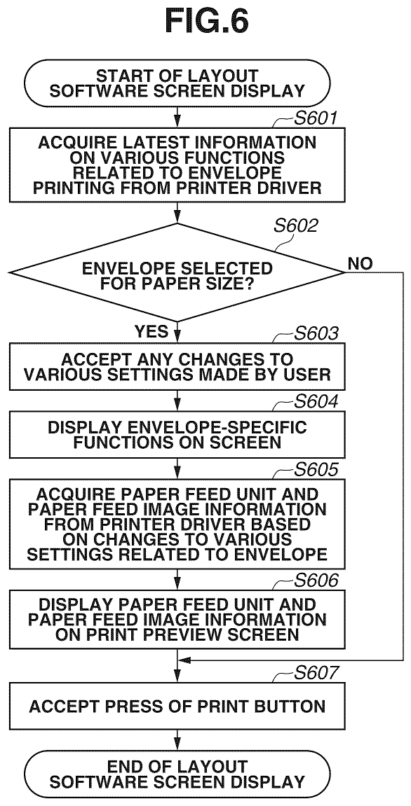

FIG. 6 illustrates a flow of operations of the layout software representing the first embodiment of the disclosure. When the layout software 104 is started and a display instruction is issued on the screen of the layout software 104, the processing is started.

In step 601 (indicated as “S601” in the drawing, and the same applies below), the layout software 104 acquires the latest information on various functions related to envelope printing from the currently selected printer driver 301 via the SDK. The various functions include some or all of the paper size 501, the print orientation 502, the flap orientation 503, the flap open/closed state 504, and the like. The layout software 104 may also acquire information on the paper feed units capable of feeding each type of paper.

In step 602, the CPU 201 determines whether the setting of the paper size 501 on the preview screen 500 is the size of an envelope. If the result of the determination in step 602 is Yes (YES in step 602), in step 603, the layout software 104 accepts any changes to other settings made by the user (an example of accepting).

In step 604, the layout software 104 displays the flap orientation 503 and the image 505 or 513 of the envelope to be displayed on the preview screen on which the setting of the flap orientation 503 is reflected. The image 505 or 513 may be generated by combining an image to be printed with an image of a shape of the envelope selected as the paper type, for example. Step 604 is an example of firstly displaying.

In step 605, the layout software 104 acquires the information on the image 512 indicating placement of the paper from the printer driver via the SDK based on the various settings (501, 502, 503, and 511) related to the envelope that have been made up to this point. In step 606, the layout software 104 displays the information on the image 512 indicating the placement of the paper obtained in step 605. Step 605 is an example of secondly displaying.

In step 607, regardless of whether the paper size is an envelope, the layout software 104 accepts the fact that the print button 514 has been pressed by the user. The printer driver 301 is notified of the settings that have been changed in the layout software 104 up to this point via the SDK. Then, the display of the layout software 104 is ended.

In step 607, the printer driver 301 may be notified of not only the settings that have been changed in the layout software 104 up to this point but also all the setting values via the SDK.

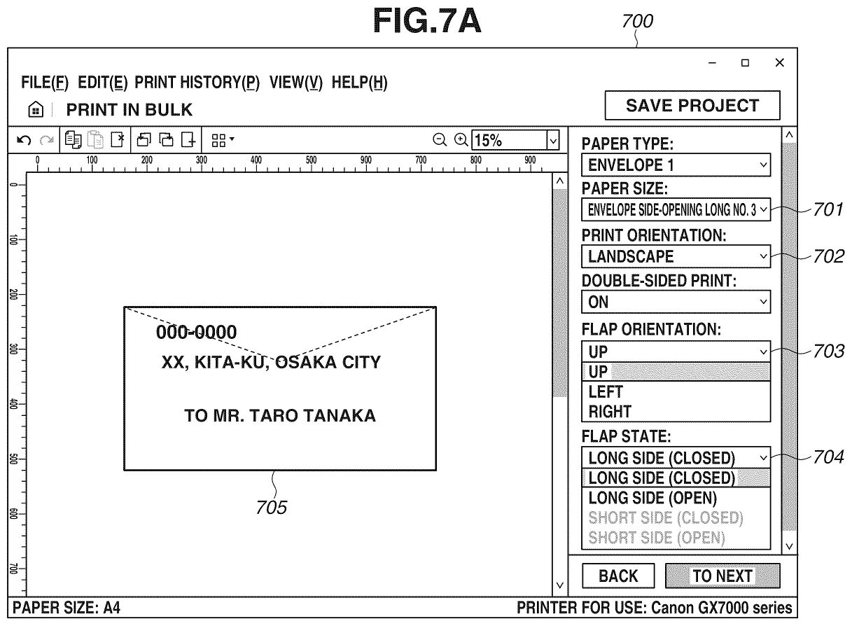

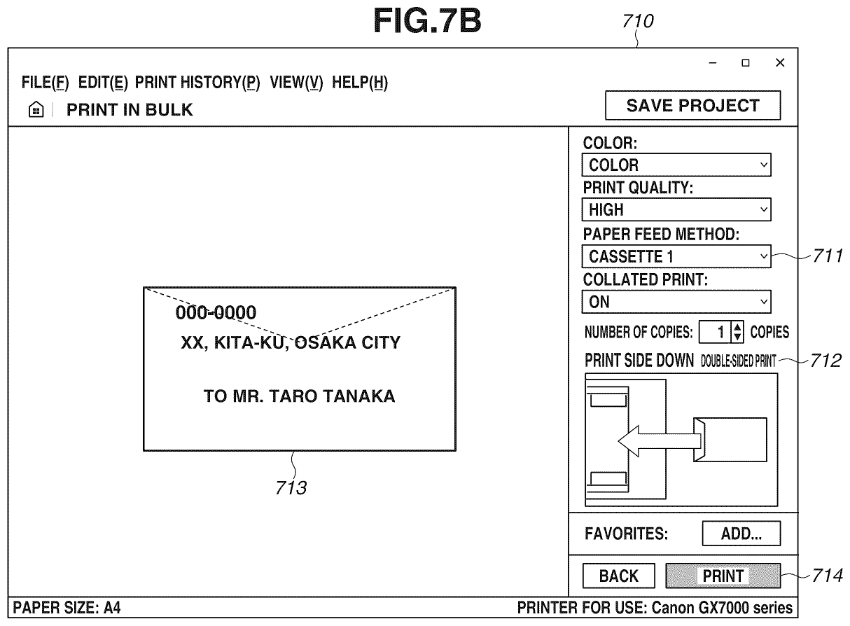

FIGS. 7A and 7B illustrate other setting cases.

FIG. 7A illustrates an example of a screen 700 of the layout software 104 for paper 701 (illustrated in the diagram as an example of an “Envelope, side-opening long No. 3”) with the flap positioned on the long side. It can be seen that a print orientation 702 is “landscape”, a flap orientation 703 is “up,” and a flap state 704 is “long side (closed)”. These settings can be visually checked in a preview 705.

FIG. 7B illustrates, in addition to various settings confirmed on the screen 700 of the layout software 104, other settings, a paper feed method 711, and an image 712 indicating the placement of paper on the printing apparatus 2 to be used for actual printing. Other settings may include “color”, “print quality”, “collated print”, and the like. Then, a print button 714 is pressed to execute printing.

In this diagram, it can be seen that the paper feed method 711 is “cassette 1” and the paper placement is “print side down” as indicated in the image 712.

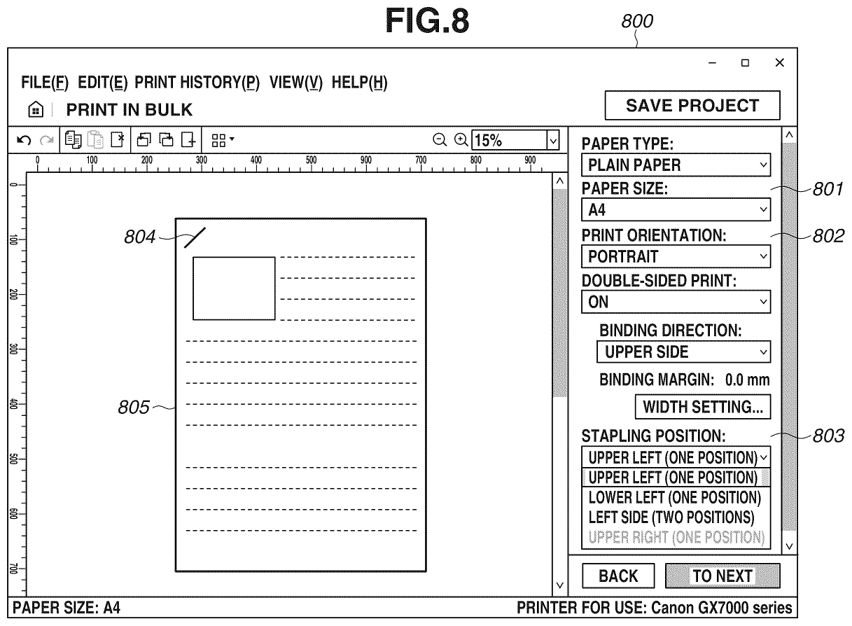

A modified example will be described. FIGS. 8 to 10C illustrate other setting cases.

FIG. 8 illustrates an example of a screen 800 of the layout software 104 in a case of making stapling settings. When a stapling position 803 is specified, an icon or the like 804 indicating the specific position where stapling will be performed is displayed in a preview screen 805. If stapling is not to be performed and “no” is selected for the stapling position 803, no icon or the like indicating the position where stapling will be performed is displayed in the preview screen 805.

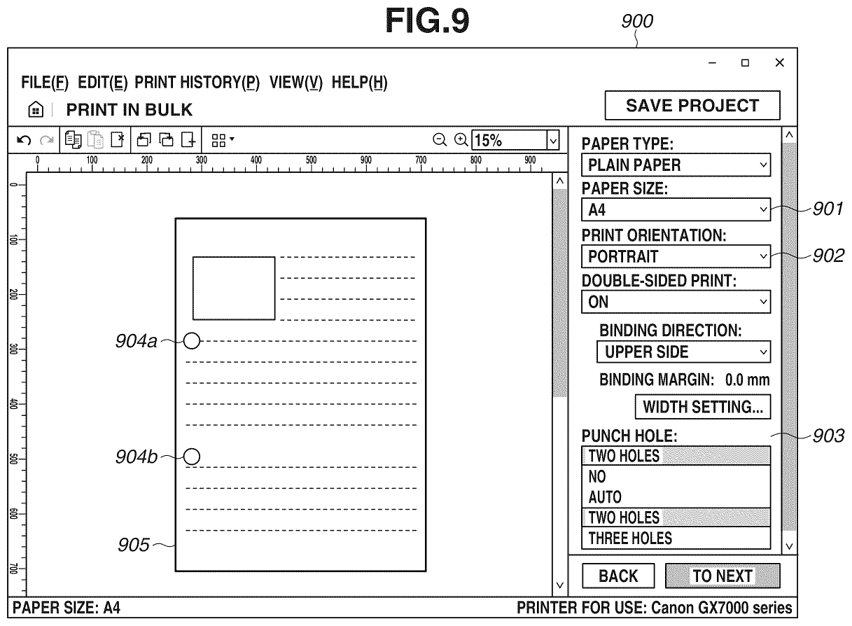

FIG. 9 illustrates an example of a screen 900 of the layout software 104 in the case of making punch hole settings. If a punch hole 903 is specified as anything other than “no”, icons 904a and 904b or the like indicating specific positions where punch holes will be formed are displayed in a preview screen 905. If punch hole processing is not to be performed and the punch hole 903 is specified as “no”, no icons or the like indicating positions where punch holes will be formed are displayed in the preview screen 905.

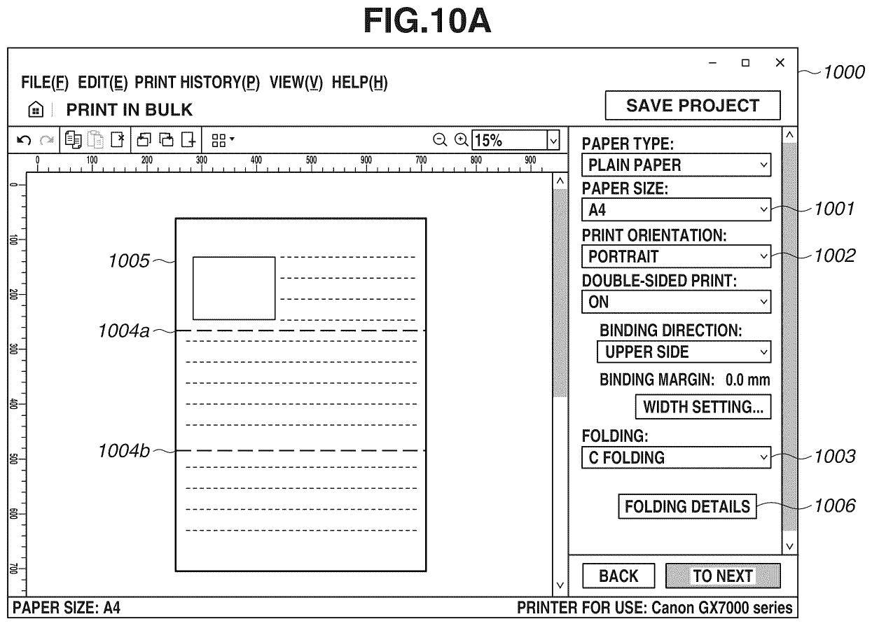

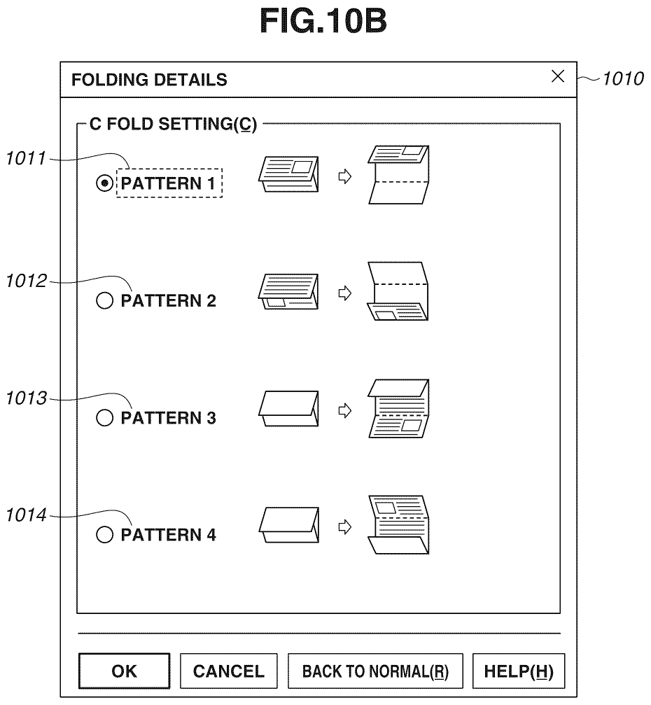

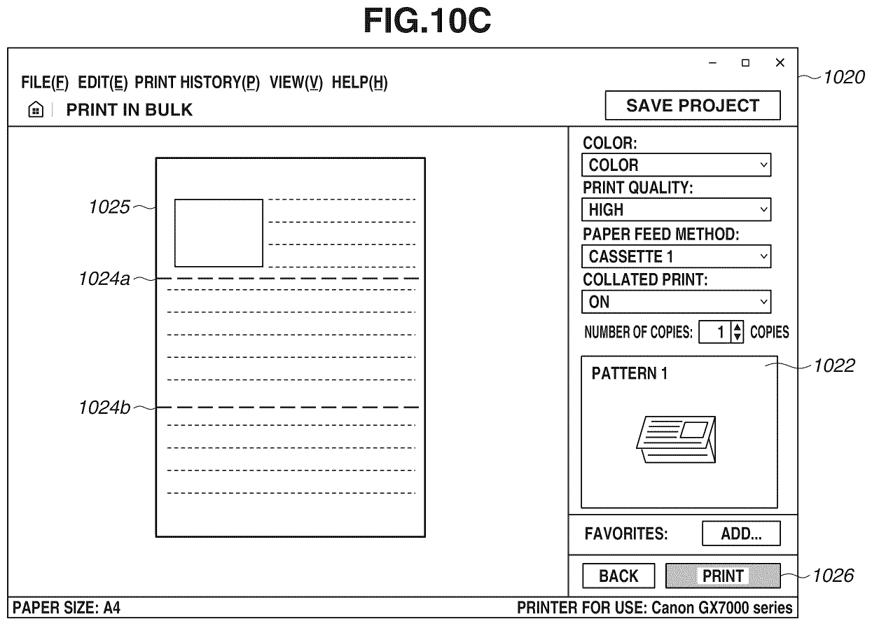

FIGS. 10A to 10C illustrate an example of a screen 1000 of the layout software 104 in the case of making folding settings. If folding 1003 is specified as anything other than “no”, icons or the like 1004a and 1004b indicating specific positions where specific folding processing will be performed are displayed in a preview screen 1005. If folding processing is not to be performed and the folding 1003 is specified as “no”, no icons or the like indicating positions where folding processing will be performed are displayed in the preview screen 1005.

FIGS. 10A to 10C describe a case where the folding 1003 is a “C fold”.

The screen opened by clicking a button for folding details 1002 will be described with reference to FIG. 10B.

In the case of a C fold, on this screen, a pattern 1 1011 indicates that the first page of the user's application data will be printed on the outside of the C fold, and will be folded such that the top of the data is positioned on the outer panel of the C fold.

A pattern 2 1012 indicates that the first page of the user's application data will be printed on the outside of the C fold and will be folded such that the top of the data is positioned on the inner panel of the C fold.

A pattern 3 1013 indicates that the first page of the user's application data will be printed on the inside of the C fold, and will be folded such that the top of the data is positioned on the inner panel of the C fold.

A pattern 4 1014 indicates that the first page of the user's application data will be printed on the inside of the C fold and will be folded such that the top of the data is positioned on the outer panel of the C fold.

An icon 1022 on which the folding settings made up to this point are reflected is displayed.

FIG. 10C illustrates the icon 1022 illustrating the actual output result based on the folding 1003 and the folding details 1002 selected on the screen 1000 and the screen 1010 of the layout software 104. A print button 1026 is pressed to execute printing.

In this diagram, it can be seen that the folding is set to “C fold” and the folding details are set to pattern 1.

In the example illustrated in FIGS. 8 to 10C, an image illustrating the placement of paper may be displayed like the image 712 in FIG. 7B. This is because there are at least two ways to place the paper, which are portrait and landscape, even in printing on plain paper such as A4-size sheets. In the case of printing on thick paper or the like, it is difficult to change the paper conveying direction (such as making a U-turn) in the apparatus, so it may be necessary to specify a paper feed tray.

Adopting this configuration makes it possible to perform processing as imaged by the user for the stapling positions, punching positions, folding positions, and image arrangement and orientation.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-147300, filed Aug. 29, 2024, which is hereby incorporated by reference herein in its entirety.

What is claimed is:

1. A non-transitory computer-readable storage medium storing executable instructions, which when executed by one or more processors of an apparatus, cause the apparatus to perform a method, the method comprising:
accepting a processing setting made by a user;
firstly displaying an image that illustrates a result of performing processing corresponding to the processing setting on an image to be printed; and
secondly displaying an image illustrating placement of paper to be processed.

2. The non-transitory computer-readable storage medium according to claim 1, wherein the processing setting includes a setting related to a type of the paper to be processed.

3. The non-transitory computer-readable storage medium according to claim 2, wherein the secondly displaying includes, in a case where an envelope is selected as the type of paper to be processed, displaying an image that illustrates an orientation of a flap, an open/closed state of the flap, and the placement of the envelope in a paper feed unit.

4. The non-transitory computer-readable storage medium according to claim 2, the method further comprising acquiring information on a position of a flap of an envelope, an open/closed state of the flap, and a paper feed unit capable of feeding the envelope, from a printer driver.

5. The non-transitory computer-readable storage medium according to claim 2, wherein the image that illustrates the result of performing the processing corresponding to the processing setting and is displayed in the firstly displaying is an image that is obtained by combining the image to be printed with an image illustrating a shape of an envelope selected as the type of the paper to be processed.

6. The non-transitory computer-readable storage medium according to claim 1, wherein the processing setting includes a setting related to stapling.

7. The non-transitory computer-readable storage medium according to claim 6, wherein the image that illustrates the result of performing the processing corresponding to the processing setting and is displayed in the firstly displaying is an image that illustrates a position of the image obtained by combining the image to be printed, and a stapling position.

8. The non-transitory computer-readable storage medium according to claim 1, wherein the processing setting includes a setting related to punching.

9. The non-transitory computer-readable storage medium according to claim 8, wherein the image that illustrates the result of the processing corresponding to the processing setting and is displayed in the firstly displaying is an image that illustrates a position of the image obtained by combining the image to be printed, and a punching position.

10. The non-transitory computer-readable storage medium according to claim 1, wherein the processing setting includes a setting related to folding.

11. The non-transitory computer-readable storage medium according to claim 10, wherein the image that illustrates the result of the processing corresponding to the processing setting and is displayed in the firstly displaying is an image that illustrates a position of the image obtained by combining the image to be printed, and a folding position.

12. A method of an apparatus, the method comprising:
accepting a processing setting made by a user;
firstly displaying an image that illustrates a result of performing processing corresponding to the processing setting on an image to be printed; and
secondly displaying an image illustrating placement of paper to be processed.

13. The method according to claim 12, wherein the processing setting includes a setting related to a type of the paper to be processed.

14. The method according to claim 13, wherein the secondly displaying includes, in a case where an envelope is selected as the type of paper to be processed, displaying an image that illustrates an orientation of a flap, an open/closed state of the flap, and the placement of the envelope in a paper feed unit.

15. The method according to claim 13, further comprising causing the apparatus to execute acquiring information on a position of a flap of an envelope, an open/closed state of the flap, and a paper feed unit capable of feeding the envelope, from a printer driver.

16. The method according to claim 13, wherein the image that illustrates the result of performing the processing corresponding to the processing setting and is displayed in the firstly displaying is an image that is obtained by combining the image to be printed with an image illustrating a shape of an envelope selected as the type of the paper to be processed.

17. The method according to claim 12, wherein the processing setting includes a setting related to stapling.

18. The method according to claim 17, wherein the image that illustrates the result of performing the processing corresponding to the processing setting and is displayed in the firstly displaying is an image that illustrates a position of the image obtained by combining the image to be printed, and a stapling position.

19. The method according to claim 12, wherein the processing setting includes a setting related to punching.

20. The method according to claim 19, wherein the image that illustrates the result of the processing corresponding to the processing setting and is displayed in the firstly displaying is an image that illustrates a position of the image obtained by combining the image to be printed, and a punching position.

21. The method according to claim 12, wherein the processing setting includes a setting related to folding.

22. The method according to claim 21, wherein the image that illustrates the result of the processing corresponding to the processing setting and is displayed in the firstly displaying is an image that illustrates a position of the image obtained by combining the image to be printed, and a folding position.
